(19) United States
(12) Patent Application Publication
(10) Pub. No.: US 2013/0097773 A1
(43) Pub. Date: Apr. 25, 2013

(54) LIGHT ASSEMBLY FOR A STEAMHEAD

(71) Applicants: Michael Pinkus, Pleasantville, NY (US); Peter Titolo, Kings Park, NY (US)

(72) Inventors: Michael Pinkus, Pleasantville, NY (US); Peter Titolo, Kings Park, NY (US)

(73) Assignee: Sussman-Automatic Corporation, Long Island City, NY (US)

(21) Appl. No.: 13/445,271

(22) Filed: Apr. 12, 2012

Related U.S. Application Data
(60) Provisional application No. 61/474,803, filed on Apr. 13, 2011.

(51) Int. Cl. F21V 21/00; B05B 1/00; A61H 33/06; F21V 5/04; H05B 37/02

(52) U.S. Cl. CPC F21V 21/00; F21V 5/04; H05B 37/02; A61H 33/065; B05B 1/00
USPC 4/524; 362/311.01; 362/231; 362/311.02; 315/362; 315/360; 239/289

(57) ABSTRACT

The light assembly is designed for use with an integral steam emitter or as an add-on with a steamhead in a pre-existing steambath installation. The assembly includes a part for engaging the end of the steam outlet pipe of a steam generator. A ring-shaped fixture carrying multiple LEDs is mounted on the pipe engaging part. A light transmissive lens is aligned with the light source fixture and has a light emitting edge. The lens has a central opening through which steam from the steam outlet pipe can pass. When the assembly is not used with a pre-existing steamhead, a steam emitter is provided with a steam inlet adapted to extend through the lens opening. The steam emitter has a hemispherical front surface with a steam outlet port located in a recess. The light source can include LEDs of different colors.

### CROSS-REFERENCE TO RELATED APPLICATIONS

Priority is claimed on Provisional Patent Application Ser. No. 61/474,803 filed Apr. 13, 2011.

### STATEMENT REGARDING FEDERALLY SPONSORED RESEARCH OR DEVELOPMENTS

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to steam generators for use in residential and commercial steambath installations and more particularly to a light assembly for a steamhead which can provided with an integral steam emitter for new steambath installations or separately as an add on to retrofit a pre-existing steamhead.

2. Description of Prior Art Including Information Disclosed Under 37 CFR 1.97 and 1.98

Steamheads for use in residential and commercial steambath installations are known in the art. The steamheads function as a terminal for the delivery of steam from a steam generator outlet pipe into a steambath enclosure.

Steamheads of various designs and configurations are known in the art and supplied by many steam generator manufacturers. However, none have the capability of providing a visual warning signal indicating that the steam generator is operational, even though steam is not actually being generated, for example before and after active steam emission. Further, none are capable of generating killing germs in the vicinity of the steamhead.

In addition, no conventional steamhead provides the benefits of chromatherapy and mood lighting. None is capable of providing low level lighting to function as a night light or can project lighted brand markings.

### BRIEF SUMMARY OF THE INVENTION

It is, therefore, a prime object of the present invention to provide a light assembly for a steamhead for use in a residential or commercial steambath installation.

It is another object of the present invention to provide a light assembly for a steamhead which can be used with an integral steam emitter in a new installation or as an add on to the steamhead in pre-existing steambath installation.

It is another object of the present invention to provide a light assembly for a steamhead which directs, diffuses and deflects steam in a specific pattern.

It is another object of the present invention to provide a light assembly for a steamhead which includes a recess to retain and volatize essential oils as the steam is emitted.

It is another object of the present invention to provide a light assembly for a steamhead which can function as a safety device by providing a visual temperature indicator.

It is another object of the present invention to provide a light assembly for a steamhead which can kill germs in the vicinity of the steamhead.

It is another object of the present invention to provide a light assembly for a steamhead which provides the benefits of chromatherapy and mood lighting.

It is another object of the present invention to provide a light assembly for a steamhead which provides low level light to act as a night light.

It is another object of the present invention to provide a light assembly for a steamhead which is capable of projecting lighted brand markings.

It is another object of the present invention to provide a light assembly for a steamhead which has an esthetically pleasing and decorative appearance.

The above noted objects are achieved by the present invention which relates to a light assembly for a steamhead designed to be mounted on the end of a steam outlet pipe of a steam generator. The steam generator has a water tank and a sensor for sensing the temperature of water in the tank. The light assembly includes a light source means and a light transmissive lens aligned with the light source means. The lens has a light emitting edge. The lens also has an opening through which steam from the steam outlet pipe can pass.

In one preferred embodiment, a steam emitter is provided as part of the light assembly. A part is provided to engage the steam outlet pipe. The steam emitter includes a steam inlet portion aligned with the opening in the lens to receive steam from the steam outlet pipe. The steam emitter also has a steam outlet port. The steam outlet port terminates in a recess on the front surface of the emitter.

The light emissive edge of the light transmissive lens is situated proximate the steam emitter. Preferably, the light emissive edge of the light transmitting lens surrounds the front surface on the steam emitter.

The light source means includes light sources such as LEDs mounted on a ring-shaped fixture. The fixture is situated in the recess defined by the pipe engaging part of the light assembly.

Preferably, the light source means includes two or more light sources each capable of emitting light of a different color.

Means are provided for energizing the light sources when the temperature of the water in the tank of the steam generator exceeds a given level. In one version, the energizing means energizes the light sources of one color when the temperature in the water tank is within a first temperature range and for energizes the light sources of another color when the temperature in the water tank is outside the first temperature range, for example, in a second temperature range.

The opening in the light transmitting lens is preferably centrally located in the lens. The steam emitter has a rearward extending portion adapted to be received within the central opening of the light transmitting lens. The steam outlet pipe extends through the pipe engaging part and aligns with the rearward extending portion of the steam emitter.

The steam emitter has a substantially hemispherical front surface with a steam outlet port. Preferably, the steam outlet port is situated in a recess in the front surface of the steam emitter.

The light transmissive lens defines a recess into which the steam emitter is adapted to be at least partially received.

The second preferred embodiment of the invention is designed for use in pre-existing steambath installations where a steamhead is already present. Accordingly, no pipe engaging part or steam emitter is required. In this embodiment, the light source means and light transmissive lens are mounted on the existing steam head.

### BRIEF DESCRIPTION OF THE SEVERAL VIEWS OF DRAWINGS

To these and to such other objects that may hereinafter appear, the present invention relates to a light assembly for a steamhead as described in detail in the following specification and recited in the annexed claims, taken together with the accompanying drawings, in which like numerals refer to like parts and in which:

FIG. 1 is a schematic diagram of a steam generator designed for use in a residential or commercial steambath in conjunction with the light assembly of the present invention;

FIG. 2 is an exploded perspective view of a steamhead with the light assembly of the present invention;

FIG. 3 is a side view of a steamhead with the light assembly of the present invention as it would appear installed in the wall of the steambath enclosure;

FIG. 4 is a front view of the steamhead of FIG. 3; and

FIG. 5 is a cross-sectional view of the steamhead of FIG. 3.

### DETAILED DESCRIPTION OF THE INVENTION

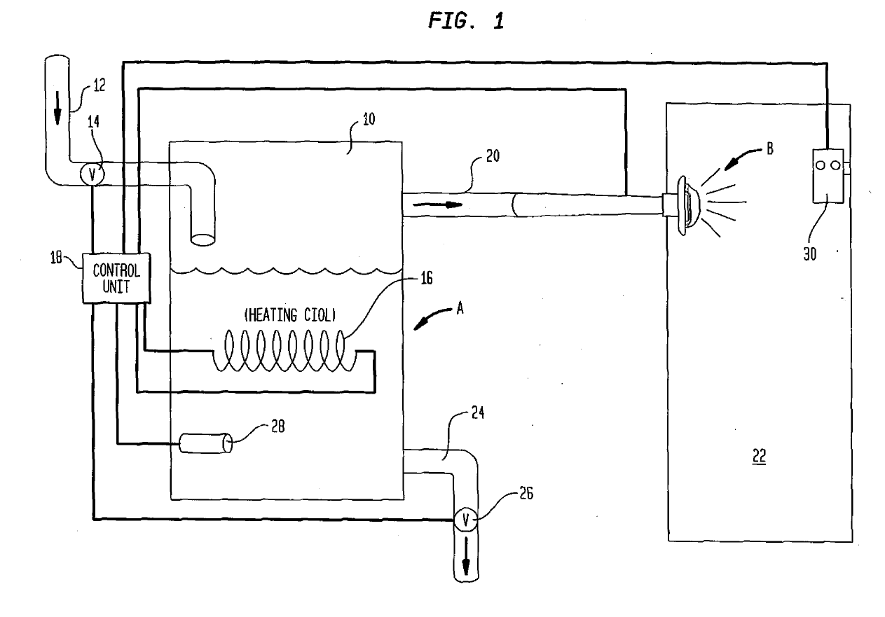

FIG. 1 shows the basic components of a steam generator, generally designated A, adapted for use with the light assembly for a steamhead of the present invention, generally designated B. Steam generator A includes a water reservoir or tank 10 into which water is introduced through a water inlet pipe 12. The flow of water into the tank is regulated by an electrically actuated valve 14.

A heating coil 16 is situated within tank 10 in order to heat the water in the tank. Coil 16 is energized by a control unit 18 to heat the water in tank 10 to create steam. The steam exits the tank through steam outlet pipe 20. Pipe 20 extends through an opening in a wall which defines steambath enclosure 22. The steamhead is attached to the end of pipe 20 and is situated within enclosure 22.

A drain pipe 24 is located near the bottom of the steam generator tank. The flow of water through drain pipe 24 is regulated by an electrically controlled valve 26. After the steam generating function is completed, and the water in the tank has cooled sufficiently, valve 26 is opened to allow the water remaining in the tank to drain. This feature insures that fresh water is available each time the steam generator is operated and prevents the growth of bacteria or other harmful organisms which might reside within the tank, if water were to remain in the tank for an extended period. Valve 26 is operated by control unit 18.

A temperature sensor 28 is situated within the steam generator tank in order to sense the temperature of the water in the tank. Sensor 28 is connected to control unit 18 which controls valves 14 and 18 to regulate the water flow into and out of the tank, and also controls the generation of steam by energizing heating coil 16.

A control panel 30 is located within steambath enclosure 22. Panel 30 allows the user to turn the steam generator on and to select the desired temperature and duration of steam generation by manipulating the buttons on the control panel. The panel is connected to the control unit of the steam generator which regulates the functions of the steam generator to supply the desired amount of steam to the steambath enclosure for the desired amount of time and thereafter, once the water in the tank has cooled, cause the water remaining in the tank to drain from the tank.

The steamhead is also connected to control unit 18 which regulates the energization of the lights in the light assembly, as explained more fully below.

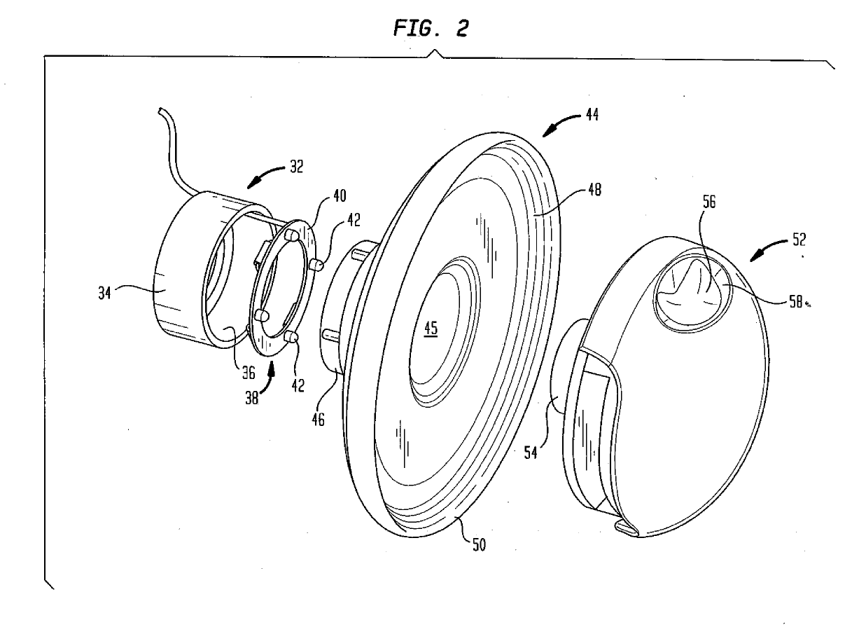

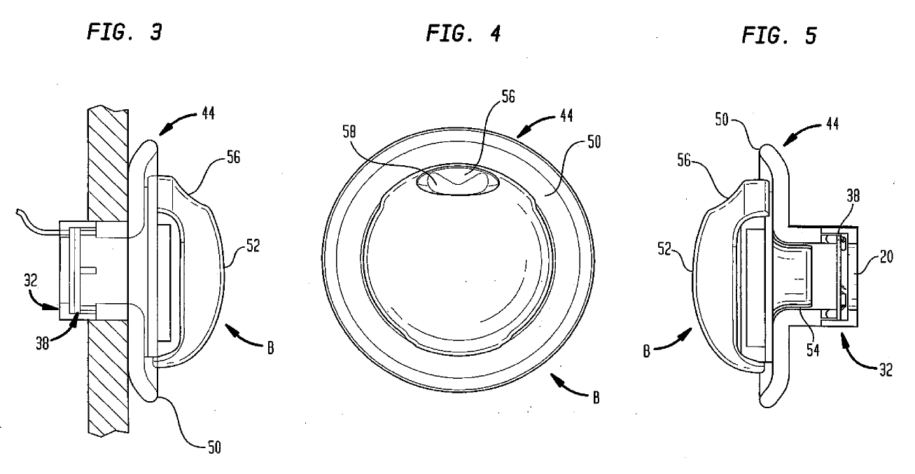

FIGS. 2-5 illustrate a first preferred embodiment of the light assembly of the present invention which includes an integral steam emitter and is designed for use in new steambath installations. The first preferred embodiment includes a cup-shaped steam outlet pipe engaging part 32 having a central opening 34 slightly larger than the outside diameter of the steam outlet pipe. Part 32 is fitted over and surrounds the end of the steam outlet pipe, which extends through opening 34 a short distance.

Part 32 defines a recess 36 into which a light source fixture 38 is received. Light source fixture 38 includes a ring-shaped member 40 upon which a plurality of light sources 42, preferably in the form of LEDs, are mounted.

A clear plastic light transmissive lens 44 is used to transmit light from the LEDs on fixture 38 to the exterior of the steamhead. Lens 44 has a central opening 45 aligned with the hollow cylindrically-shaped rear portion 46 of the lens. Rear portion 46 of the lens is adapted to be received within recess 36 of part 32 in alignment with and proximate to light source fixture 38, which surrounds the end of the steam outlet pipe. The cup-shaped forward portion 48 of lens 44 extends from portion 46 and terminates in an edge 50 which edge is visible from the front of the steamhead. Light from the LEDs on fixture 38 enters the rear edge of portion 46 of lens 44, travels along the body of the lens, and exits the lens at the edge 50 of the front portion 48 of the lens.

In this preferred embodiment, the light assembly is provided with an integral steam emitter 52. Steam emitter 52 is formed of plastic suitable for use at high temperatures and is received in the recess in forward portion 48 of lens 44. Emitter 52 has a rearward extending cylindrical portion 54 which is received in central opening 45 of lens 44 and thus is situated adjacent the end of steam outlet pipe 20. Emitter 52 acts as the steam outlet.

Emitter 52 has a steam outlet port 56 situated in a recess 58 on the front hemispherical surface 52 of the emitter. Recess 58 can be filled with essential oils which are volatized by the steam as the steam exits the steam outlet port 56. The shape of port 56 is chosen such that it directs, diffuses and deflects the emitted steam in a specific pattern.

The second preferred embodiment of the light assembly of the present invention is provided for use in pre-existing steambath installations and thus does not include a pipe engaging part or an integral steam emitter. In this embodiment, the light source fixture 38 and light transmissive lens 44 are adapted for attachment to the existing steamhead. Installation of the light assembly requires that the pre-existing steamhead be detached from the end of the steam outlet pipe. Thereafter, the light assembly consisting of the light source fixture and light transmissive lens are mounted over the end of the steam outlet pipe and the steamhead is reattached to the end of the steam outlet pipe.

Regardless of which embodiment of the light assembly is employed, the effect of the light assembly is the same. As best seen in FIG. 4, which is a front view of the light assembly with the integral steam emitter of FIG. 2, the light emitting edge 50 of lens 44 appears as a ring that surrounds the front surface of the light emitter. The light assembly functions the same whether it is designed for use in a new or pre-existing installation.

In one version of the invention, all of the LEDs are of the same color, for example, red. In this version, the LEDs may be energized by control unit 18 when the steam generator is turned on or whenever the temperature of the water in the steam generator tank above a pre-set level is sensed by sensor 28. Thus, the steamhead will light up red as a visual warning indicator that the steam generator is operational.

In a second version, two sets of LEDs, each of a different color, such as red and green, could be used. In this version, the red LEDs could be energized when the steam generator is turned on or whenever the water temperature in the tank exceeds a pre-set level, as in the first embodiment. At all other times when the steam generator is functioning, the green LEDs could be energized to indicate that the steam generator is operating but the water temperature is below the pre-set level.

In a third version, three sets of LEDs, each of a different color, such as red, green and yellow, could be used. In this version, the green LEDs could be energized whenever the water temperature in the tank in one temperature range, for example, when the water is heating up or cooling down. The red LEDs could be energized when the water temperature in the tank is within a second temperature range, for example, when the water is hot enough create a dangerous condition. At all other times, the yellow LEDs could be energized at a low level, for instance to act as a night light.

In a fourth version, LEDs can be selected to emit light in the ultraviolet spectrum. Such light is known to kill germs. Thus, the light assembly of the present invention could be used to eliminate germs in the area surrounding the steamhead.

As an alternative to controlling the energization of the LEDs in response to the temperature of the water in the tank, the control unit 18 can be provided with a timing circuit. The timing circuit is actuated when the steam generator is turned off and tracks the time after the steam generator is turned off. When a predetermined time (sufficient for the water in the tank to cool) has elapsed, the control unit causes valve 26 to open to drain the water in the tank and at the same time causes the light source to change color, for example, from red to green. The same timing circuit could be used to change the color of the light source once again, for example from green to yellow such that the light assembly functions as a night light, after an additional time period.

It will now be appreciated that the present invention relates to a light assembly for a steamhead which can be used with an integral steam emitter for a new steambath installation or as an add-on designed to retrofit a pre-existing steamhead by installing the light source fixture and lens on the existing steamhead.

The light assembly is installed so the lens and steam emitter/steamhead are partially exposed in the steam environment with the balance hidden behind the wall of the steambath. The portion that is exposed in the steambath enclosure is constructed of a materials required to perform in a steam environment and have the required UL and other certifications for a safety.

The clear plastic lens is edge lighted to transmit light from the unexposed portion of the assembly to the exposed portion. The low voltage powered device can be connected to an independent power source, directly to the steam generator control unit or to the steam generator control unit via the control cable.

The light assembly provides various colors of light to the steamhead via edge lighting so as to create a decorative lighting effect, a chromatherapy effect, or light the steam in the steambath. The device acts as a safety device which signals the temperature of the steamhead before, during and after active steam emission. In addition, it can provide UV germ killing light to the surroundings proximate to the steamhead. It can project lighted brand markings situated on the front source. It can also provide low level lighting (night light).

The assembly creates a back lit steamhead powered by multiple light sources for new and pre-existing steambath installations. A clear Lexan or other light transmissive material is used to construct the lens which acts as a conduit light in a manner similar to fiber optics (edge lighting). This “lens” functions with the lights to produce a back lit halo around the steamhead. Additionally, the steam itself will function as a light diffuser and/or a reflective medium to create multi-colored atmospheric visual effects.

The steam outlet engaging part or escutcheon could be made from a high temperature clear plastic. The light sources are provided on a fixture received in the escutcheon portion of the steamhead. The lights may be electrically connected to the steam generator though the same connection that controls the drain valve which automatically flushes water from the reservoir after the steam unit is turned off and the water cools. Using this connection will provide the user with feedback of a hot or potentially hot steamhead.

In one version of the invention, the light assembly is energized only when the steam generator is in operation and to signal hot steamhead surface temperatures. For a period of time after steam operation has ceased, the steamhead remains hot. When the generator is powered up for the first time, the lighting on the steamhead will be off since there is no voltage. As soon as the user turns the steam generator on at the control panel, a sustained voltage is sent simultaneously to the automatic flush valve to close the drain valve and to the light assembly of the steamhead to turn the lights on. After the generator turns off (either timed out or user turns it off) the voltage to the automatic flush valve and to the light assembly remains present for a preset amount of time. That time interval is selected to be more than adequate for the steamhead to cool off. After that time, the voltage is cut, the automatic flush valve opens, and the light assembly turns off.

Lighting up the steamhead also serves to highlight the steamhead and the steam emission location within a steamy steambath enclosure to assist users in avoiding a hot surface or steam emissions.

When the assembly consists of two or more sets of different color lights, it could be connected though a relay that will switch the light assembly from red when hot to green when cool after a given time period by selecting the different color sets. A timing circuit specifically for this feature could be incorporated into the steam generator control unit. Further, a temperature sensing circuit as described above could be used to control the light assembly that will turn the light on/off with temperature. If an integrated timing feature with the flush valve is not used, a simple delay off could be used instead of the same circuit as the flush valve.

In addition, the steambath control panel could be provided with a button to permit the user to manually turn the light assembly on and off, as well as to control the color of the lights.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A light assembly for a steamhead for installation on the end of the steam outlet pipe of a steam generator of the type having a water tank, the light assembly comprising light source means, means for mounting said mounting light source means, and a light transmissive lens comprising a portion situated proximate said light source means and a light emitting edge, said lens having an opening through which steam from the steam outlet pipe can pass.

2. The assembly of claim 1 further comprising means for engaging the end of the steam outlet pipe and for mounting said light source means, a steam emitter, said steam emitter comprising a steam inlet aligned with the steam outlet pipe, and a surface with a steam outlet port, said light emissive edge of said light transmissive lens being situated proximate said steam emitter surface.

3. The assembly of claim 1 for use with a pre-existing steamhead including means for engaging the steam outlet pipe, the steamhead having a steam inlet aligned with the steam outlet pipe, and a surface with a steam outlet port, said light emissive edge of said light transmissive lens being situated proximate said steamhead surface.

4. The assembly of claim 1 wherein said light source means comprises a ring shaped fixture.

5. The assembly of claim 1 wherein said light source means is situated in a recess in said pipe engaging means.

6. The assembly of claim 2 wherein said light emissive edge of said light transmitting lens surrounds at least a portion of said steam emitter surface.

7. The assembly of claim 3 wherein said light emissive edge of said light transmitting lens surrounds at least a portion of said steamhead surface.

8. The assembly of claim 1 wherein said light source means comprises a LED.

9. The assembly of claim 1 wherein said light source means comprises two or more light sources each capable of emitting light of a different color.

10. The assembly of claim 1 further comprising means for sensing the temperature of the water in the steam generator tank and for energizing said light source means when said temperature exceeds a given level.

11. The assembly of claim 9 further comprising means for sensing the temperature of the water in the steam generator tank and for energizing one of said light sources when said temperature is within a first temperature range and for energizing the other of said light sources when said temperature is outside said first temperature range.

12. The assembly of claim 9 further comprising means for sensing the temperature of the water in the steam generator tank and for energizing one of said light sources when said temperature is within a first temperature range and for energizing the other of said light sources when said temperature is within a second temperature range.

13. The assembly of claim 1 wherein said opening in said light transmitting lens is centrally located.

14. The assembly of claim 1 wherein the outlet pipe extends into said central opening of said light transmissive lens.

15. The assembly of claim 2 wherein said steam emitter surface has a substantially hemispherical shape.

16. The assembly of claim 15 wherein said light transmissive lens surface defines a recess into which said steam emitter is adapted to be at least partially received.

17. The assembly of claim 1 further comprising timing means for energizing said light source means a predetermined time period after the steam generator is turned off.

18. The assembly of claim 9 further comprising timing means for energizing one of said light sources when said temperature is within a first temperature range and for energizing the other of said light sources when said temperature is outside said first temperature range.

19. The assembly of claim 9 further comprising timing means for energizing one of said light sources when said temperature is within a first temperature range and for energizing the other of said light sources when said temperature is within a second temperature range.

20. A steamhead for installation on the end of a steam outlet pipe for a steam generator of the type having a water tank and a sensor for sensing the temperature of water in the tank, the assembly comprising means for engaging the end of the steam outlet pipe, means for mounting said light source means on said pipe engaging means, a light transmissive lens aligned with said light source means and having a light emitting edge, and a steam emitter, said steam emitter comprising a steam inlet aligned with the steam outlet pipe, a surface with a steam outlet port, wherein said light emissive edge of said light transmissive lens is situated proximate said steam emitter surface.

21. The assembly of claim 20 wherein said light source means comprises a light source mounted on a ring-shaped fixture.

22. The assembly of claim 21 wherein said fixture is situated in a recess in said pipe engaging means.

23. The assembly of claim 20 wherein said light emissive edge of said light transmitting lens surrounds at least a portion of said steam emitter surface.

24. The assembly of claim 20 wherein said light source means comprises a LED.

25. The assembly of claim 20 wherein said light source means comprises two or more light sources each capable of emitting light of a different color.

26. The assembly of claim 20 further comprising means for energizing said light source means when said temperature exceeds a given level.

27. The assembly of claim 25 further comprising means for energizing one of said light sources when said temperature is within a first temperature range and for energizing the other of said light sources when said temperature is outside said first temperature range.

28. The assembly of claim 25 further comprising means for energizing one of said light sources when said temperature is within a first temperature range and for energizing the other of said light sources when said temperature is within a second temperature range.

29. The assembly of claim 20 wherein said light transmitting lens has a central opening and said steam emitter comprises a portion adapted to be received within said central opening.

30. The assembly of claim 29 wherein the steam outlet pipe extends into said central opening and aligns with said steam emitter portion.

31. The assembly of claim 20 wherein said steam emitter has a substantially hemispherical shaped surface with a steam outlet port.

32. The assembly of claim 20 wherein said light transmissive lens defines a recess into which said steam emitter is adapted to be at least partially received.
